(19) United States
(12) Patent Application Publication
(10) Pub. No.: US 2021/0347549 A1
(43) Pub. Date: Nov. 11, 2021

(54) PACKAGING

(71) Applicant: BBR Packaging Technologies Ltd., Orwell Cove (CA)

(72) Inventor: Brian FORTUNE, Orwell Cove (CA)

(21) Appl. No.: 17/313,787

(22) Filed: May 6, 2021

(30) Foreign Application Priority Data
May 7, 2020 (CA) 3080074

(51) Int. Cl. B65D 77/20; B65D 1/34; B65D 85/50; B65B 7/16

(52) U.S. Cl. CPC B65D 77/2024; B65B 7/164; B65D 85/50; B65D 1/34

(57) ABSTRACT

A method of packaging live oysters and clams including the steps of providing a sealable container, wherein the container includes a plastic tray having an interior volume and an upper peripheral edge, placing the live seafood in the container, and sealing the container with a layer of flexible film including a sheet of flexible sealable film sealed to the upper edge of the tray, the flexible film having an Oxygen Transmission Rate (OTR) of at least 1500.

### BACKGROUND

The present invention relates to the field of live oyster and hardshell clam (hereinafter collectively referred to as oysters and clams) packaging. In particular, the present invention provides an improved live oyster and clam packaging method, and package, that improves mortality rate of packaged live oysters and clams, as compared with known live oyster and clam packaging.

In the marketing of seafood, in particular oysters and clams, it is essential to deliver a live product, to permit a restaurant or seafood market to offer the best possible product to the consuming public. Bringing live oysters or clams to inland markets can be problematic, and expensive. The most obvious, and expensive, way to do so is to expedite transport of the live animals by air, preferably in an aqueous environment simulating their natural environment. This is effective, but expensive, because of the weight involved.

There have been several packaging methods proposed to keep live seafood alive during transit. In JP58129930, the product is packaged in a mixture of O₂ and CO₂, after it has been injected with alkaline solution of pH 7-12. This method, then, requires additional handling of each item, and the use of an additive thereto, and is therefore not economically feasible.

In U.S. Pat. No. 6,238,716, a packaging method using 50%-90% of a CO₂ and O₂ mix including 25%-50% 02 is proposed. It has been found to be effective on some shellfish, but is ineffective in relatively long time frame shipping and storage.

Applicants previous patent CA 2489738 dated 2007 Feb. 2 discloses a method for packaging live seafood, in particular mussels using a modified atmosphere gas mixture of CO₂ and O₂ in a package sealed with a multi-layer high barrier film. The gas mixture is preferably about 80% O₂.

Typically, oysters must be alive when being prepared for consumption. An indication that the oyster is alive is that its shell will remain tightly closed, or if slightly open, will close when irritated.

Once harvested, oysters can be kept alive by being kept dry, in chilled conditions. Traditionally, the method of packaging oysters is to pack them in wooden boxes or plastic or waxed cardboard boxes, open at the top. This type of packaging is not appropriate for direct to consumer retail.

### SUMMARY

The present invention provides:
1. A method of packaging live oysters or clams comprising the steps of providing a sealable container, wherein said container comprises a plastic tray having an interior volume and an upper peripheral edge, placing said live oysters and clams in said container, and sealing said container with a layer of flexible film comprising a sheet of flexible sealable film sealed to the upper edge of said tray, said flexible film having an Oxygen Transmission Rate (OTR) of at least 1500 cm³O₂/m²/day bar.
2. A method as in (1), wherein said sealable container is a leak-proof plastic tray.
3. A method as in (1), wherein the OTR of said flexible film is in the range of 1500 to 15000 cm³O₂/m²/day bar.
4. A method as in (1), wherein the OTR of said flexible film in in the range of 10,000 cm³ O₂/m²/day bar to above 250,000 cm³ O₂/m²/day bar.
5. A method as in (4), wherein the OTR of said flexible film in in the range of 10,000 cm³ O₂/m²/day bar to above 250,000 cm³ O₂/m²/day bar.
6. A package for use with live oysters or clams comprising a tray with a flat floor and side walls extending upwardly from the floor, the side walls being of a sufficient height to permit the tray to accommodate a number of oysters or clams, said side wall being contiguous with one another and said floor to define a leak proof open tray, and the upper edges of said side walls formed as a flat lip extending around the upper peripheral edge of said tray; and a layer of flexible sealable film sealed to the lip around upper peripheral edge of said tray, said film having an Oxygen Transmission Rate (OTR) of at least 1500 cm³O₂/m²/day bar.
7. A package as in (6), wherein the tray is substantially rectangular, and the corners of said rectangular tray are rounded.
8. A package as in (7), wherein said tray is molded from plastic.
9. A package as in (7), wherein said film has an OTR selected to permit sufficient O₂ to enter into said package, while maintaining the leak proof aspect of the package.
10. A package as in (7), wherein said film has an OTR in the range of 1500 to 15000 cm³ O₂/m²/day bar.

11. A package as in (6), wherein the OTR of said flexible film in in the range of 10,000 cm³ O₂/m²/day bar to above 250,000 cm³ O₂/m²/day bar.
12. A package as in (11), wherein the corners of said tray are rounded.
13. A package as in (6), wherein the OTR of said flexible film in in the range of 10,000 cm³ O₂/m²/day bar to above 250,000 cm³ O₂/m²/day bar.

14. A package as in (13), wherein the corners of said tray are rounded.

### BRIEF DESCRIPTION OF THE DRAWINGS

In drawings that illustrate the present invention by way of example:

FIG. 1 is a perspective view of a tray for a package for oysters or clams according to the present invention.

FIG. 2 is a front view of the package shown in FIG. 1, with film applied thereto.

FIG. 3 is a cross-sectional view through line III-III in FIG. 2.

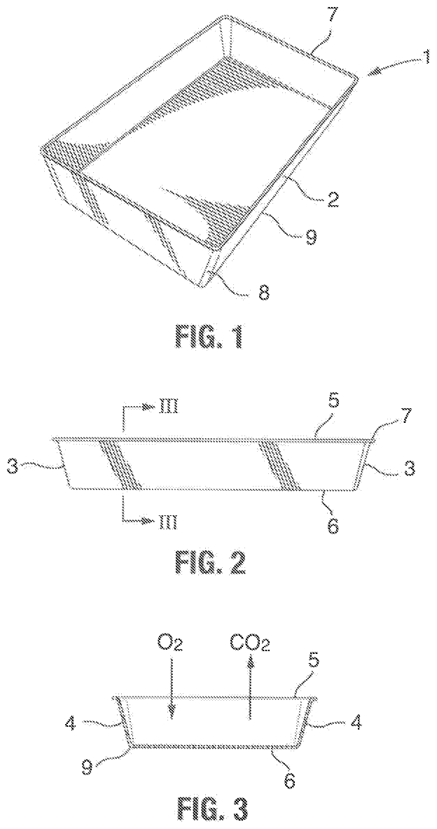

### DETAILED DESCRIPTION

As shown in the drawings, the present invention relates to a package, and also to a method for packaging live oysters and clams. The package comprises a tray 2 made of suitable food-grade leak proof plastic material. The selection of a leak proof plastic material will be a matter of choice for one skilled in the art.

The tray 2 is molded from a single piece of plastic so as to be entirely leak proof. The corners 8 are rounded, to eliminate or reduce the chance of cracking the plastic. Similarly, the transition edge 9 between the end panels 3 and the floor panel 6 of the tray 2, as well as the transition edge 9 between the side panels 4 and the floor panel 6 are also rounded, to prevent or minimize cracks in the tray 2, which would cause the package to leak.

The tray 2 is generally rectangular in a preferred embodiment. This permits the most efficient packaging of multiple trays, and also facilitates use of machines to assist in packaging. Moreover, as will be explained herein, the tray 2 is sealed with a flexible film 5, so use of rectangular trays minimizes film usage and waste. Other shapes, such as circular or hexagonal, may be used for tray 2, if desired.

A flat lip 7 is formed around the upper perimeter of the tray 2, and is continuous along each side panel 3, font and back panels 4, and corners 8. The function of lip 7 is to provide continuous flat surface for the application of film 5 to cover tray 2.

After extensive experimentation, the Applicant has determined that an improved oyster mortality rate is obtainable using a package filled with air. Oxygen may be added if desired. The package therefore comprises a formed leak-proof plastic tray 2, sealed with a food-compatible film 5 having an Oxygen transmission rate (OTR) of at least 1500 OTR. The OTR of the film may be higher, up to 250K or higher. In this regard, if a completely leak-proof package is desired, it is preferred to use film with an OTR of 1,500 to 15,000. In practice, however, and with appropriate handling, use of film in the range of 10,000 OTR to 250,000 OTR is appropriate.

OTR is measured in cm³ of O₂ per m² per day bar. It has been found that at levels in excess of about 15000 OTR that the packaging ceases to be leak-proof.

It will be noted, as regards high OTR film, that highly permeable film of about 10,000 OTR has been used to package fresh fish in vacuum packs. It is used in this type of fish packaging by Plastopil for its ability to adhere to the fish fillets, thereby to present the product attractively, and the fact that it's very high permeability promotes the growth of anaerobic bacteria. This use is different from the Applicant's, in that use for fish packaging is not designed to keep the fish alive. Moreover, one would typically not expect that packaging for fresh fish, which stays fresher in low O₂ environment to be useful in packaging for live oysters and clams, which require an environment containing enough O₂ to survive. Live oysters and clams require fairly constant replenishment of O₂ in their environment. However, when such film is used to package fresh fish, there is in fact no atmosphere inside the package, as the film is vacuum sealed around the fish piece.

The film 5 of the package of the present invention is applied in a similar manner to that of CA 2489738, around the lip 7 of the formed plastic tray 2 in which the oysters or clams have been deposited. In this regard, the film 5 can be heat sealed to the perimeter of plastic tray 2, to lip 7 around its upper edge. It can alternatively be adhered by sonic welding or appropriate adhesives.

The film may be, for instance Cryovac™ film. Extremely low to zero oyster mortality rate can be obtained with the packaging of the present invention.

1. A method of packaging live oysters or clams comprising the steps of providing a sealable container, wherein said container comprises a plastic tray having an interior volume and an upper peripheral edge, placing said live oysters and clams in said container, and sealing said container with a layer of flexible film comprising a sheet of flexible sealable film sealed to the upper edge of said tray, said flexible film having an Oxygen Transmission Rate (OTR) of at least 1500 cm³O₂/m²/day bar.

2. A method as claimed in claim 1, wherein said sealable container is a leak-proof plastic tray.

3. A method as claimed in claim 1, wherein the OTR of said flexible film is in the range of 1500 to 15000 cm³O₂/m²/day bar.

4. A method as claimed in claim 1, wherein the OTR of said flexible film in in the range of 10,000 cm³ O₂/m²/day bar to above 250,000 cm³ O₂/m²/day bar.

5. A method as claimed in claim 4, wherein the OTR of said flexible film in in the range of 10,000 cm³ O₂/m²/day bar to above 250,000 cm³ O₂/m²/day bar.

6. A package for use with live oysters or clams comprising a tray with a flat floor and side walls extending upwardly from the floor, the side walls being of a sufficient height to permit the tray to accommodate a number of oysters or clams, said side wall being contiguous with one another and said floor to define a leak proof open tray, and the upper edges of said side walls formed as a flat lip extending around the upper peripheral edge of said tray; and a layer of flexible sealable film sealed to the lip around upper peripheral edge of said tray, said film having an Oxygen Transmission Rate (OTR) of at least 1500 cm³O₂/m²/day bar.

7. A package as claimed in claim 6, wherein the tray is substantially rectangular, and the corners of said rectangular tray are rounded.

8. A package as claimed in claim 7, wherein said tray is molded from plastic.

9. A package as claimed in claim 7, wherein said film has an OTR selected to permit sufficient O₂ to enter into said package, while maintaining the leak proof aspect of the package.

10. A package as claimed in claim 7, wherein said film, has an OTR in the range of 1500 to 15000 cm³ O₂/m²/day bar.

11. A package as claimed in claim 6, wherein the OTR of said flexible film in in the range of 10,000 cm³ O₂/m²/day bar to above 250,000 cm³ O₂/m²/day bar.

12. A package as claimed in claim 11, wherein the corners of said tray are rounded.

13. A package as claimed in claim 6, wherein the OTR of said flexible film in in the range of 10,000 cm³ O₂/m²/day bar to above 250,000 cm³ O₂/m²/day bar.

14. A package as claimed in claim 13, wherein the corners of said tray are rounded.
